(19) United States
(12) Patent Application Publication
(10) Pub. No.: US 2026/0249924 A1
(43) Pub. Date: Aug. 27, 2026

(54) VEHICLE FRAME STRUCTURE

(71) Applicant: TOYOTA JIDOSHA KABUSHIKI KAISHA, Aichi-ken (JP)

(72) Inventors: Ayaka KAGAMI, Inazawa-shi (JP); Soshiro MURATA, Toyota-shi (JP)

(21) Appl. No.: 19/538,988

(22) Filed: Feb. 13, 2026

(30) Foreign Application Priority Data
Feb. 21, 2025 (JP) 2025-027342

(51) Int. Cl. B62D 25/08; B62D 21/03; B62D 21/15

(52) U.S. Cl. CPC B62D 25/082; B62D 21/03; B62D 21/152; B62D 21/155

(57) ABSTRACT

A vehicle frame structure, includes: a frame main body including a wheel house and that is integrally molded by casting; a member portion, at least a part thereof being included in the frame main body, the member portion including an upper plate, a lower plate, and at least one middle plate, each of the plates having a plate thickness direction in a vertical direction and extending in a front-rear direction, and the at least one middle plate being provided between the upper and lower plates; and a deformation starting point portion that is provided at an outer end portion of the plates, and that includes a first protrusion portion that protrudes in an upward direction at the upper plate, a second protrusion portion that protrudes in a downward direction at the lower plate, and a third protrusion portion that protrudes in the downward direction at the middle plate.

### CROSS-REFERENCE TO RELATED APPLICATION

This application is based on and claims priority under 35 USC 119 from Japanese Patent Application No. 2025-027342 filed on Feb. 21, 2025, the disclosure of which is incorporated by reference herein.

### BACKGROUND

### Technical Field

The present disclosure relates to a vehicle frame structure.

### Related Art

WO 2022/031991 discloses a structure in which, in a vehicle frame structure of a vehicle front portion integrally molded by casting, an impact absorbing portion (cast crumple zone, crushable zone) is provided along the vehicle front-rear direction.

The impact absorbing portion described in the above-mentioned document is provided adjacent to a wheel house, and since the wheel house is bent in the vehicle upward direction, there is a possibility that the frame may be broken so as to be convex toward the vehicle upper side at the time of a front collision, and there is a risk that a collision load cannot be sufficiently absorbed.

### SUMMARY

In view of the above-described circumstances, the present disclosure provides a vehicle frame structure capable of ensuring a necessary energy absorption amount.

A vehicle frame structure according to a first aspect of the present disclosure includes: a frame main body that includes a wheel house and that is integrally molded by casting; a member portion, at least a part of the member portion being included in the frame main body, the member portion including an upper plate, a lower plate, and at least one middle plate, each of the upper plate, the lower plate, and the at least one middle plate having a plate thickness direction in a vehicle vertical direction and extending in a vehicle front-rear direction, and the at least one middle plate being provided between the upper plate and the lower plate; and a deformation starting point portion that is provided at an outer side end portion, in the vehicle front-rear direction, of each of the upper plate, the lower plate, and the at least one middle plate, and that includes a first protrusion portion that protrudes in a vehicle upward direction at the upper plate, a second protrusion portion that protrudes in a vehicle downward direction at the lower plate, and a third protrusion portion that protrudes in the vehicle downward direction at the at least one middle plate.

In the first aspect, the deformation starting point portion is provided at the outer side end portion, in the vehicle front-rear direction, of each of the upper plate, the lower plate, and the at least one middle plate, and includes a first protrusion that protrudes in the vehicle upward direction at the upper plate, a second protrusion that protrudes in the vehicle downward direction at the lower plate, and a third protrusion that protrudes in the vehicle downward direction at the at least one middle plate. Therefore, at the time of a collision, since the member portion can be drawn toward a vehicle lower side due to the third protrusion, which protrudes in the vehicle downward direction, of the middle plate, it is possible to avoid or reduce possibility of a bending mode in which the member portion is bent so as to be convex toward the vehicle upper side. As a result, by avoiding such bending mode, the member portion may be efficiently compressively deformed at the time of a collision, whereby a required energy absorption amount can be ensured.

A vehicle frame structure according to a second aspect of the present disclosure is the configuration according to the first aspect, wherein: the member portion further includes plural vertical plates that have a plate thickness direction in the vehicle front-rear direction and that connect the at least one middle plate with the upper plate and the lower plate, respectively, the plural vertical plates being provided at intervals in the vehicle front-rear direction; and the first protrusion portion, the second protrusion portion, and the third protrusion portion are provided offset from the plural vertical plates in the vehicle front-rear direction.

In the second aspect, the first protrusion, the second protrusion, and the third protrusion, that is, the deformation starting point portion, are provided so as to be offset from the vertical plates in the vehicle front-rear direction. As a result, deformation at the deformation starting point portion may not be hindered by staggering the vertical plates and the deformation starting point portion, and by configuring chambers with the vertical plates, the member portion may be broken in order from the outer side toward the inner side in the vehicle front-rear direction.

A vehicle frame structure according to a third aspect of the present disclosure is the configuration according to the above-described aspects, wherein the second protrusion portion is provided at an outer side in the vehicle front-rear direction than the first protrusion portion.

In the third aspect, since the second protrusion is provided further toward the outer side in the vehicle front-rear direction than the first protrusion portion, when a collision load is input at the time of a collision, the second protrusion will be the start point of deformation, and the member portion is deformed, whereby the mode of breaking may be stabilized.

A vehicle frame structure according to a fourth aspect of the present disclosure is the configuration according to the above-described aspects, wherein the deformation starting point portion includes a fragile portion.

In the fourth aspect, since the deformation starting point portion includes a fragile portion, when the member portion is crushed from the outer side in the vehicle front-rear direction starting from the deformation starting point portion at the time of a collision, the first protrusion, the second protrusion, and the third protrusion, as the deformation starting point portion, may be more easily deformed.

A vehicle frame structure according to a fifth aspect of the present disclosure is the configuration according to the above-described aspects, wherein the deformation starting point portion is configured by respective bent portions in which the upper plate, the lower plate, and the at least one middle plate are bent.

In the fifth aspect, since the deformation starting point portion is configured by respective bent portions in which the upper plate, the lower plate, and the at least one middle plate are bent, the member portion may be crushed from the outer side in the vehicle front-rear direction, with the bent portion as the starting point, at the time of a collision.

A vehicle frame structure according to a sixth aspect of the present disclosure is the configuration according to the above-described aspects, wherein the at least one middle plate includes a plate thickness change portion that has a plate thickness that is greater at an inner side than at an outer side in the vehicle front-rear direction.

In the sixth aspect, since the at least one middle plate includes a plate thickness change portion that has a plate thickness that is greater at the inner side than at the outer side in the vehicle front-rear direction, the plate thickness becomes thicker from the outer side toward the inner side in the vehicle front-rear direction, whereby the member portion can easily be crushed from the outer side in the vehicle front-rear direction at the time of a collision.

A vehicle frame structure according to a seventh aspect of the present disclosure is the configuration according to the above-described aspects, wherein the deformation starting point portion is further provided between vertical plates adjacent to each other in the vehicle front-rear direction.

In the seventh aspect, since a deformation starting point portion is further provided between vertical plates adjacent to each other in the vehicle front-rear direction, a deformation starting point portion is also provided at the inner side in the vehicle front-rear direction of the deformation starting point portion that is provided at the outer end portion in the vehicle front-rear direction, whereby the mode of breaking of the member portion may be further stabilized.

As described above, the vehicle frame structure according to the present disclosure may ensure a required energy absorption amount.

### BRIEF DESCRIPTION OF THE DRAWINGS

FIG. 1 is a perspective view schematically illustrating an example of the main parts of a vehicle front portion to which a vehicle frame structure according to a first exemplary embodiment is applied, as viewed from the left oblique front side of the vehicle.

FIG. 2 is a side view schematically illustrating the main parts of the vehicle of FIG. 1.

FIG. 3 is a perspective view of a front side member of FIG. 1, as viewed from the left oblique front side.

FIG. 4 is a side view schematically illustrating the main parts of a modified example of the front side member.

FIG. 5 is a side view schematically illustrating the main parts of a front side member of a vehicle to which a vehicle frame structure according to a second exemplary embodiment is applied.

FIG. 6 is a side view schematically illustrating the main parts of a front side member of a vehicle to which a vehicle frame structure according to a third exemplary embodiment is applied.

FIG. 7 is a side view schematically illustrating the main parts of a front side member of a vehicle to which a vehicle frame structure according to a fourth exemplary embodiment is applied.

FIG. 8 is a perspective view schematically illustrating the main parts of a front side member of a vehicle to which a vehicle frame structure according to a fifth exemplary embodiment is applied.

### DETAILED DESCRIPTION

### First Exemplary Embodiment

Explanation follows regarding a vehicle 12 to which a vehicle frame structure 10 according to a first exemplary embodiment of the present disclosure has been applied, with reference to the drawings. In the present specification and the drawings, components having substantially the same functional configuration are denoted by the same reference numerals, and duplicate explanation thereof is omitted. Furthermore, in each of the drawings, the arrow FR indicates the front side in a vehicle front-rear direction, and the arrow UP indicates the upper side in a vehicle vertical direction. The arrow LH indicates the left side in a vehicle width direction, and in the present exemplary embodiment, indicates an outer side in the vehicle width direction. Hereinafter, explanation with simple reference to front and rear, up and down, and left and right directions, unless otherwise specified, refers to the front and rear in the vehicle front-rear direction, up and down in the vehicle vertical direction, and the left and right in a vehicle left-right direction (the vehicle width direction), respectively.

### Schematic Configuration of Vehicle Front Portion

First, explanation follows regarding the vehicle 12 to which the vehicle frame structure 10 according to the present exemplary embodiment is applied. For example, the vehicle 12 has a power unit including a motor, an engine, or the like as a drive source, and is an electric vehicle and a fuel cell vehicle which travels with the power generated by the power unit.

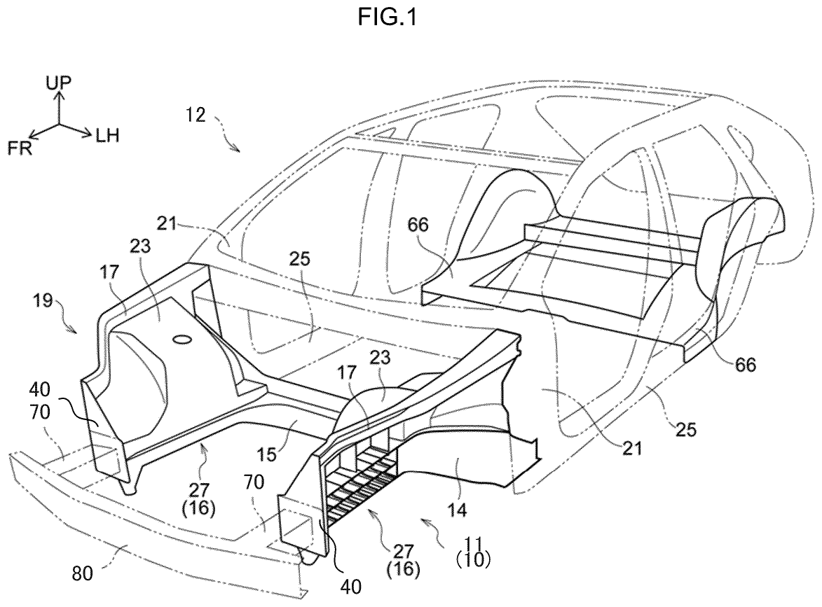

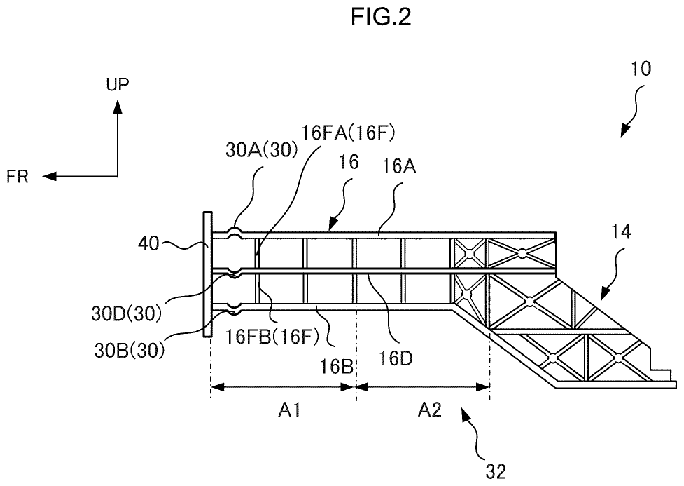

FIG. 1 is a perspective view of the vehicle 12 as viewed from the left oblique front side, and FIG. 2 is a side view schematically illustrating the main parts of the vehicle 12 of FIG. 1. FIG. 1 schematically illustrates the main parts of a frame of a front portion of the vehicle 12. As illustrated in FIG. 1 and FIG. 2, the vehicle frame structure 10, a crash-box 70, a front bumper 80 and the like are provided at the front portion of the vehicle 12 as a frame of the vehicle 12.

The vehicle frame structure 10 includes a frame main body 11 that is integrally molded by casting, and a front side member 16 as a member portion included in the frame main body 11.

Front side members 16 are respectively provided at both side portions, in the vehicle width direction, at the vehicle front portion, and extend along the vehicle front-rear direction. A power unit, which is not illustrated in the drawings, is provided between the left and right front side members 16. Furthermore, at end portions, at a vehicle front side, of the left and right front side members 16, crash-boxes 70, which have an impact absorbing structure that is capable of absorbing impact energy with respect to a load in an axial direction, respectively extend along the vehicle front-rear direction. At front ends of the left and right crash-boxes 70, the front bumper 80, which is a frame of the front bumper, extends along the vehicle width direction.

Although the front bumper 80 and the crash-boxes 70 are described herein as separate parts, the front bumper 80 and the crash-boxes 70 may be integrated. In a case in which the front bumper 80 and the crash-boxes 70 are integrated, the above-described impact absorbing structure may be applied to the so-called crash-box 70, or may be applied to both the crash-box 70 and the front side member 16.

On the other hand, at the rear side of the left and right front side members 16, wheel houses 14 in which wheels (not illustrated in the drawings) are arranged are provided, respectively, and a right wheel house 14 and a left wheel house 14 are connected by a cross member 15.

An apron upper member 17 is provided at a vehicle width direction outer side and a vehicle vertical direction upper side of the front side member 16. The apron upper member 17 configures an upper side frame at the front portion of the vehicle 12. The apron upper member 17 extends in the vehicle front-rear direction along the front side member 16, and a rear end portion of the apron upper member 17 is connected to a front pillar 21. Furthermore, a suspension tower portion 23 is integrally formed at the apron upper member 17. A rocker 25 extending along the vehicle front-rear direction and configuring a frame of a vehicle body side portion is provided at a rear side, in the vehicle front-rear direction, of the wheel house 14.

In the present exemplary embodiment, as an example, the frame main body 11 includes the left and right front side members 16, the left and right wheel houses 14, the cross member 15, the apron upper members 17, and the suspension tower portions 23, and is integrally molded by casting using an aluminum alloy, a magnesium alloy, or the like as a material. For this reason, each member of the front side members 16, the left and right wheel houses 14, the cross member 15, the apron upper members 17, and the suspension tower portions 23 has an open cross-section that is open in the draft direction of the mold at the time of casting.

In the present exemplary embodiment, one side and another side in the vehicle width direction may be the draft direction of the mold. Therefore, the cross-section of each member is an open cross-section that is open at at least one side of the outer side or the inner side in the vehicle width direction. Although the outer side (left side) of the left wheel house 14 is not illustrated in FIG. 1, it is actually open as illustrated in FIG. 2. Furthermore, the frame main body 11 may be formed by all of the cross member 15, the apron upper members 17, and the suspension tower portions 23 or a part of the cross member 15, the apron upper members 17, and the suspension tower portions 23 being separate parts.

Detailed explanation follows regarding the main parts of each configuration of the front side member 16, the crash-box 70, the suspension tower portion 23, and the front bumper 80.

### Front Side Member 16 and Crash-Box 70

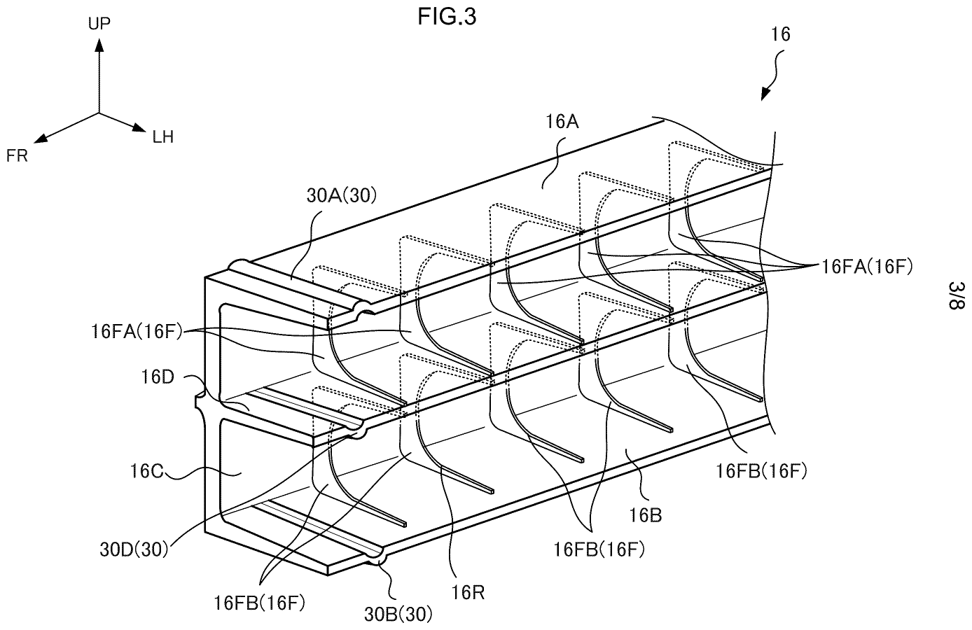

FIG. 3 is a perspective view of the front side member 16 of FIG. 1, as viewed from the left oblique front side. As illustrated in FIG. 3, the front side member 16 extends along the vehicle front-rear direction as described above. As an example, the front side member 16 includes an upper plate 16A, a lower plate 16B, a rear plate 16C, and a middle plate 16D, and has a substantially E-shaped open cross-sectional shape that is open toward the outer side in the vehicle width direction.

The upper plate 16A extends in the vehicle width direction and the vehicle front-rear direction with the vehicle vertical direction being its plate thickness direction, and configures an upper wall of the front side member 16, which has its longitudinal direction in the vehicle front-rear direction. The lower plate 16B is provided spaced apart from the upper plate 16A at the lower side in the vehicle vertical direction, and extends in the vehicle width direction and the vehicle front-rear direction with the vehicle vertical direction being its plate thickness direction, and configures a lower wall of the front side member 16, which has its longitudinal direction in the vehicle front-rear direction.

The rear plate 16C configures an inner wall that connects an inner end portion, in the vehicle width direction, of the upper plate 16A and an inner end portion, in the vehicle width direction, of the lower plate 16B. The middle plate 16D is provided between the upper plate 16A and the lower plate 16B, extends from an intermediate part, in the vehicle vertical direction, of the rear plate 16C, and extends toward the outer side in the vehicle width direction, and partitions the internal space of the front side member 16 vertically into two rows.

Plural ribs 16F are provided at each of the upper and lower rows, separated by the middle plate 16D, of the front side member 16 at intervals in the vehicle front-rear direction. As an example, the plural ribs 16F are respectively erected from the outer surface of the rear plate 16C. In other words, the ribs 16F connect the upper plate 16A and the lower plate 16B via the middle plate 16D. By means of the plural ribs 16F, the internal space of each row is partitioned into plural chambers, and the open cross-section of the front side member 16 is reinforced.

In the present exemplary embodiment, as an example, the ribs 16F include first ribs 16FA that are provided between the upper plate 16A and the middle plate 16D and that are connected to the upper plate 16A and the middle plate 16D, and second ribs 16FB that are provided between the middle plate 16D and the lower plate 16B and that are connected to the middle plate 16D and the lower plate 16B. In the present exemplary embodiment, the positions of the first ribs 16FA provided at the upper row and the second ribs 16FB provided at the lower row coincide with each other in the vehicle front-rear direction. Note that these positions are not limited and may be different. Furthermore, as an example, the ribs 16F have a gouged out portion 16R with a tip that is gouged out (or R-cut) in an arc shape from the outer side toward the inner side in the vehicle width direction.

The gouged out portion 16R is not limited to an arc shape, and may have a rectangular shape, or the shape may be appropriately modified. Furthermore, the gouged out portion 16R may not be formed in the ribs 16F. Moreover, in the present exemplary embodiment, as described above, since the front side member 16 is formed by casting, a draft angle is formed in the ribs 16F, and the gouged out portion 16R has a larger width on progression toward the open end, that is, on progression toward the outer side in the vehicle width direction.

Here, in the present exemplary embodiment, “connect” means a state of being integrally formed, unlike a state in which separate members are connected to each other. In other words, in the front side member 16 of the present exemplary embodiment, the upper plate 16A, the lower plate 16B, the rear plate 16C, the middle plate 16D, and the ribs 16F are integrally molded. In the present exemplary embodiment, the ribs 16F (the first ribs 16FA and the second ribs 16FB) are an example of vertical plates.

When a collision load is input from the vehicle front side to the front side member 16, the upper plate 16A, the middle plate 16D, and the lower plate 16B, which configure plural chambers formed between adjacent ribs 16F in the upper and lower rows of the front side member 16, deform in the vehicle vertical direction and are sequentially broken from the vehicle front side, whereby a breaking load is generated. In this process, the collision load is absorbed. In this regard, deformation starting point portions 30, serving as deformation starting points, are provided at the upper plate 16A, the lower plate 16B, and the middle plate 16D, respectively.

The deformation starting point portions 30 are provided at an outer end portion, in the vehicle front-rear direction, of each of the upper plate 16A, the lower plate 16B, and the middle plate 16D. In the present exemplary embodiment, as illustrated in FIG. 2, the deformation starting point portions 30 are provided at the front end portion in the vehicle front-rear direction. Specifically, at the front side member 16, the deformation starting point portions 30 are provided so as to be offset, toward the rear side, from a vertical plate formed at the most front side in the vehicle front-rear direction. In the present exemplary embodiment, as illustrated in FIG. 1 and FIG. 2, a front wall 40, which forms a front end of the frame main body 11, serves as a vertical plate. In a case in which the front end of the frame main body 11 is configured by a rib 16F instead of the front wall 40, the rib 16F serves as a vertical plate.

As illustrated in FIG. 2, in the present exemplary embodiment, as an example, deformation starting point portions 30 are formed between the front wall 40 and the rib 16F that is adjacent to the front wall 40 to the vehicle rear side, that is, the first rib 16FA and the second rib 16FB, and is formed substantially in the center in the vehicle front-rear direction.

The deformation starting point portions 30 include a first protrusion 30A that protrudes towards a vehicle upward direction at the upper plate 16A, a second protrusion 30B that protrudes towards a vehicle downward direction at the lower plate 16B, and a third protrusion 30D that protrudes towards the vehicle downward direction at the middle plate 16D. As illustrated in FIG. 3, the first protrusion 30A is formed by bending the upper plate 16A upward in an arc shape as viewed from the vehicle width direction, and extends over the entire vehicle width direction of the upper plate 16A.

As illustrated in FIG. 3, the second protrusion 30B is formed by bending the lower plate 16B downward in an arc shape as viewed from the vehicle width direction, and extends over the entire vehicle width direction of the lower plate 16B. Similar to the second protrusion 30B, the third protrusion 30D is formed by bending the middle plate 16D downward in an arc shape as viewed from the vehicle width direction, and extends over the entire vehicle width direction of the middle plate 16D.

As illustrated in FIG. 1 and FIG. 2, the front wall 40, which is connected to an end portion, at the vehicle rear side, of the crash-box 70 is formed at a front end portion, at the vehicle front side, of the front side member 16. In the present exemplary embodiment, although the front side member 16 and the front wall 40 are integrally formed by casting, the configuration is not limited to this and they may be configured as separate members.

A rear end portion of the crash-box 70 is joined to the front end portion, at the vehicle front side, of the front side member 16 via the front wall 40. In the present exemplary embodiment, “join” includes, in addition a case in which the crash-box 70 is directly fastened to the front wall 40 of the front side member 16 by bolts, welding, or the like as described above, a case in which the crash-box 70 and the front side member 16 are indirectly fastened or fixed to each other via a connection portion or the like of the crash-box 70 and the front side member 16.

At the front side member 16 configured as described above, as an example, the middle plate 16D has a plate thickness change portion 32, which has a plate thickness that is greater at the inner side (rear side) than at the outer side (front side) in the vehicle front-rear direction. As illustrated in FIG. 2, the plate thickness change portion 32 is configured by, for example, a first region A1 from a rear end surface of the front wall 40 to a rear end surface of the third rib 16F adjacent to the rear side, and a second region A2 from the rear end surface of the rib 16F to a front end of the wheel house 14. The middle plate 16D has different plate thicknesses at the first region A1 and the second region A2.

Specifically, a plate thickness T1 of the middle plate 16D included in the first region A1 is formed to be thinner than a plate thickness T2 of the middle plate 16D included in the second region A2. For example, the plate thickness T1 is from 2.5 mm to 3 mm (inclusive), and the plate thickness T2 is from 4.0 mm to 4.5 mm (inclusive). The plate thickness T1 of the middle plate 16D included at the first region A1 and the plate thickness T2 of the middle plate 16D included at the second region A2 may be configured so that the plate thickness gradually increases on progression from the front side toward the rear side, or may be configured so that the plate thickness locally changes at the boundary between the first region A1 and the second region A2.

### Suspension Tower Portion 23

As illustrated in FIG. 1, suspension tower portions 23 are respectively erected from the upper surfaces of the pair of front side members 16, and extend between the front side member 16 and the apron upper member 17. Furthermore, the front side member 16, the apron upper member 17, and the suspension tower portion 23 are integrally formed. An upper end portion of a shock absorber of a suspension, which is not illustrated in the drawings, is fixed to the suspension tower portion 23.

### Front Bumper 80

The front bumper 80 is a hollow beam-shaped frame and extends along the vehicle width direction. The front bumper 80 is connected in a state in which an end portion at the outer side, in the vehicle width direction, of the front bumper 80 protrudes toward the outer side in the vehicle width direction beyond an end portion, at the vehicle front side, of the crash-box 70. Furthermore, in plan view, the front bumper 80 is gently bent so that an intermediate part, in the vehicle width direction, of the front bumper 80 is convex toward the vehicle front side.

### Operation and Effects

Next, explanation follows regarding operation and effects of the first exemplary embodiment.

In the vehicle frame structure 10 of the first exemplary embodiment, the deformation starting point portions 30 of the front side member 16 are provided at the front end portion of each of the upper plate 16A, the lower plate 16B, and the middle plate 16D, and includes the first protrusion 30A that protrudes in the vehicle upward direction at the upper plate 16A, the second protrusion 30B that protrudes in the vehicle downward direction at the lower plate 16B, and the third protrusion 30D that protrudes in the vehicle downward direction at the middle plate 16D. For this reason, at the time of a front collision, since the front side member 16 can be drawn toward a vehicle lower side due to the third protrusion 30D, which protrudes in the vehicle downward direction, of the middle plate 16D, it is possible to suppress a bending mode in which the front side member 16 is bent so as to be convex toward the vehicle upper side. As a result, by avoiding such bending mode, the front side member 16 may be efficiently compressively deformed at the time of a front collision, whereby a required energy absorption amount may be ensured.

Furthermore, in the vehicle frame structure 10 of the first exemplary embodiment, since the deformation starting point portion 30, that is, the third protrusion 30D, is also provided at the middle plate 16D, a deformation amount of the front end portion of the front side member 16 at the time of a front collision becomes greater compared to a case in which the third protrusion 30D is not provided, and for example, the deformation (strain) of the chamber positioned at the fifth from the front is reduced. As a result, the tendency to deform in order from the front end portion of the front side member 16 at the time of a front collision can be increased.

Furthermore, in the vehicle frame structure 10 of the first exemplary embodiment, the first protrusion 30A, the second protrusion 30B, and the third protrusion 30D, that is, the deformation starting point portions 30, are provided so as to be offset, toward the rear side in the vehicle front-rear direction, from the front wall 40 as a vertical plate. As a result, deformation of the deformation starting point portions 30 may not be inhibited by staggering the front wall 40 and the deformation starting point portions 30, and by configuring the chambers with the front wall 40, the front side member 16 may be broken in order from the front.

Furthermore, in the vehicle frame structure 10 of the first exemplary embodiment, since the middle plate 16D has the plate thickness change portion 32, which has a plate thickness that is greater at the rear side than at the front side in the vehicle front-rear direction, the plate thickness becomes thicker toward the vehicle rear side, whereby the member portion can easily be crushed from the vehicle front side at the time of a front collision.

In the present exemplary embodiment, although the first protrusion 30A, the second protrusion 30B, and the third protrusion 30D are formed by bending the upper plate 16A, the lower plate 16B, and the intermediate plate 16D into an arc shape, respectively, the present disclosure is not limited to an arc shape. For example, the first protrusion 30A, the second protrusion 30B, and the third protrusion 30D may have a rectangular shape, a triangular shape, or any shape. Furthermore, the protrusion amounts of the first protrusion 30A, the second protrusion 30B, and the third protrusion 30D may be the same as or different from each other.

Furthermore, in the present exemplary embodiment, as an example, although the first protrusion 30A, the second protrusion 30B, and the third protrusion 30D extend over the entire vehicle width direction, the present disclosure is not limited thereto. For example, the first protrusion 30A, the second protrusion 30B, and the third protrusion 30D may extend to a central portion in the vehicle width direction, or may extend further to the inner side or the outer side than the center. Moreover, in the present exemplary embodiment, as an example, although the first protrusion 30A, the second protrusion 30B, and the third protrusion 30D extend toward the inner side from the outer end portion in the vehicle width direction, the present disclosure is not limited thereto. For example, the first protrusion 30A, the second protrusion 30B, and the third protrusion 30D may be formed only at the central portion in the vehicle width direction, or may extend toward the outer side from the inner end portion in the vehicle width direction.

### Modified Example

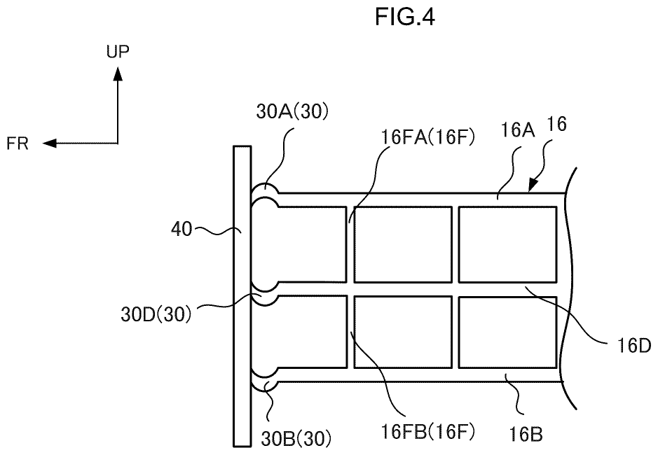

In the above-described first exemplary embodiment, although the deformation starting point portions 30 provided at the front side member 16 are formed between the front wall 40 and the rib 16F adjacent to the front wall 40 to the vehicle rear side, and is formed substantially in the center in the vehicle front-rear direction therebetween, the present disclosure is not limited thereto. FIG. 4 schematically illustrates the main parts of a modified example of the front side member 16 of the above-described exemplary embodiment.

As illustrated in FIG. 4, the deformation starting point portions 30 are formed at the front end portion instead of the substantially center in the vehicle front-rear direction between the front wall 40 and the rib 16F adjacent to the front wall 40 to the vehicle rear side. In other words, the first protrusion 30A, the second protrusion 30B, and the third protrusion 30D, which are the deformation starting point portions 30, are formed adjacent to the front wall 40 without being offset from the front wall 40 in the vehicle front-rear direction.

As a result, since the deformation starting point portions 30 are formed adjacent to the front wall 40 without being offset from the front wall 40 in the vehicle front-rear direction, a load from the front wall 40 may be directly transmitted to the deformation starting point portions 30 at the time of a front collision.

### Second Exemplary Embodiment

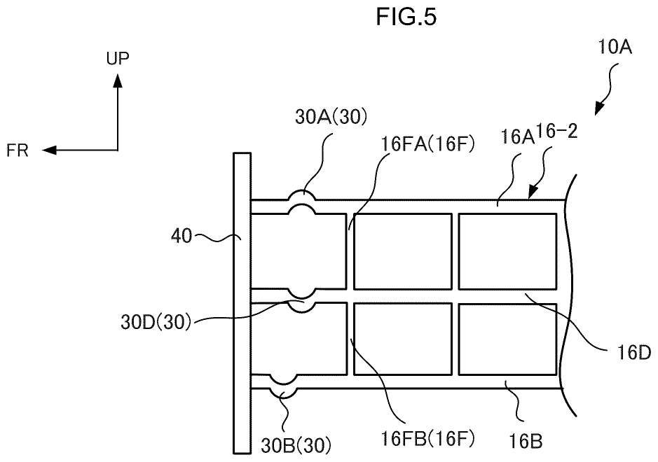

Next, explanation follows regarding a vehicle frame structure 10A according to a second exemplary embodiment of the present disclosure. FIG. 5 schematically illustrates a side view of the main parts of a front side member 16-2 of a vehicle to which the vehicle frame structure 10A according to the second exemplary embodiment has been applied. In the vehicle frame structure 10A according to the second exemplary embodiment, the same components as those of the above-described first exemplary embodiment are denoted by the same reference numerals, and explanation thereof is omitted.

As illustrated in FIG. 5, the positions of the deformation starting point portions 30 of the front side member 16-2 of the second exemplary embodiment are different from the above-described first exemplary embodiment. In the front side member 16-2, the second protrusion 30B is provided further to the front side in the vehicle front-rear direction than the first protrusion 30A and the third protrusion 30D. In other words, the second protrusion 30B is provided so that the position of the second protrusion 30B is different from the first protrusion 30A and the third protrusion 30D in the vehicle front-rear direction. Specifically, as an example, the second protrusion 30B is provided so that the position thereof in the vehicle front-rear direction is between the front wall 40 and the position of the first protrusion 30A and the third protrusion 30D.

### Operation and Effects

Next, explanation follows regarding operation and effects of the second exemplary embodiment.

In the vehicle frame structure 10A according to the second exemplary embodiment, the second protrusion 30B is provided further to the front side in the vehicle front-rear direction than the first protrusion 30A and the third protrusion 30D. Therefore, when a collision load is input at the time of a front collision, the second protrusion 30B serves as the starting point of deformation, and may stabilize the mode of breaking by deforming the front side member 16.

### Third Exemplary Embodiment

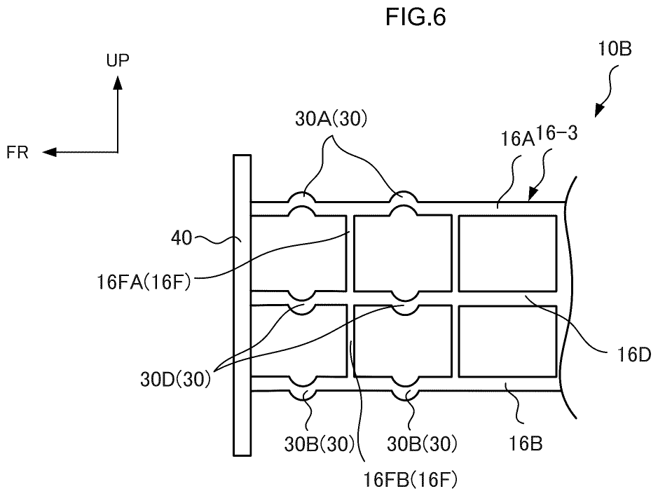

Next, explanation follows regarding a vehicle frame structure 10B according to a third exemplary embodiment of the present disclosure. FIG. 6 schematically illustrates a side view of the main parts of a front side member 16-3 of a vehicle to which the vehicle frame structure 10B according to the third exemplary embodiment has been applied. In the vehicle frame structure 10B according to the third exemplary embodiment, the same components as those of the above-described first exemplary embodiment are denoted by the same reference numerals, and explanation thereof is omitted.

As illustrated in FIG. 6, the number of deformation starting point portions 30 of the front side member 16-3 of the third exemplary embodiment is different from that of the first exemplary embodiment. In addition to the configuration of the first exemplary embodiment, the front side member 16-3 also has deformation starting point portions 30 between the rib 16F adjacent to the rear side of the front wall 40 and the rib 16F adjacent to the rear of the aforementioned rib 16F. In other words, a first protrusion 30A, a second protrusion 30B, and a third protrusion 30D are respectively additionally provided at the upper plate 16A, the lower plate 16B, and the middle plate 16D, which configure the chambers adjacent to the rear side of the chambers at the front end in the vehicle front-rear direction. In the present exemplary embodiment, as an example, the protrusion amounts of the first protrusion 30A, the second protrusion 30B, and the third protrusion 30D at the front side are greater than the protrusion amounts of the first protrusion 30A, the second protrusion 30B, and the third protrusion 30D at the rear side. Note that the configuration is not limited to this, and the protrusion amounts may be the same.

### Operation and Effects

Next, explanation follows regarding operation and effects of the third exemplary embodiment.

In the vehicle frame structure 10B according to the third exemplary embodiment, since additional deformation starting point portions 30 are further provided between adjacent ribs 16F in the vehicle front-rear direction, deformation starting point portions 30 are also provided at the rear side of the deformation starting point portions 30 provided at the front end portion in the vehicle front-rear direction, whereby the mode of breaking of the member portion may be further stabilized. Furthermore, since the protrusion amounts of the first protrusion 30A, the second protrusion 30B, and the third protrusion 30D at the front side are greater than the protrusion amounts of first protrusion 30A, the second protrusion 30B, and the third protrusion 30D at the rear side, the front side member 16 may easily be crushed from the vehicle front side at the time of a front collision.

### Fourth Exemplary Embodiment

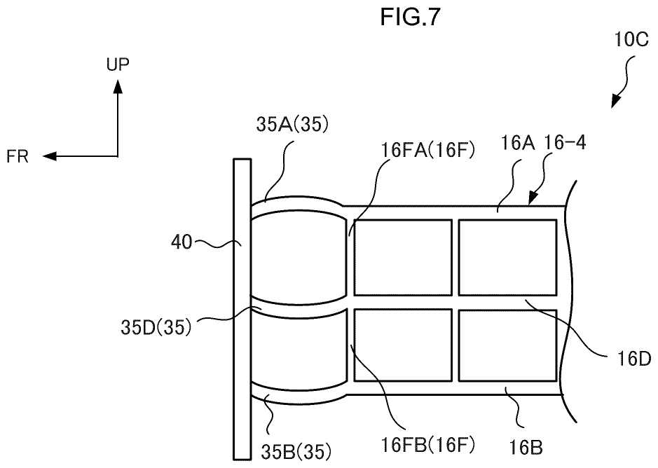

Next, explanation follows regarding a vehicle frame structure 10C according to a fourth exemplary embodiment of the present disclosure. FIG. 7 schematically illustrates a side view of the main parts of a front side member 16-4 of a vehicle to which the vehicle frame structure 10C according to the fourth exemplary embodiment has been applied. In the vehicle frame structure 10C according to the fourth exemplary embodiment, the same components as those of the above-described first exemplary embodiment are denoted by the same reference numerals, and explanation thereof is omitted.

As illustrated in FIG. 7, the front side member 16-4 of the fourth exemplary embodiment includes bent portions 35 as deformation starting point portions that have a shape different from the above-described exemplary embodiments. While at least a part in the vehicle front-rear direction of the deformation starting point portions 30 of the above-described exemplary embodiments protrudes at each of the upper plate 16A, the lower plate 16B, and the middle plate 16D, the bent portions 35 of the present exemplary embodiment protrude so that the entire length in vehicle front-rear direction at the first front chambers are bent as illustrated in FIG. 7.

Specifically, the bent portions 35 include a first protrusion 35A that protrudes in the vehicle upward direction at the upper plate 16A, a second protrusion 35B that protrudes in the vehicle downward direction at the lower plate 16B, and a third protrusion 35D that protrudes in the vehicle downward direction at the middle plate 16D. As illustrated in FIG. 7, as viewed from the vehicle width direction, the first protrusion 35A is formed in an arc shape in which the upper plate 16A has the rear surface of the front wall 40 as a start point and the front surface of the rib 16F adjacent to the rear side of the front wall 40 as an end point, and is bent upward.

Furthermore, as illustrated in FIG. 7, as viewed from the vehicle width direction, the second protrusion 35B is formed in an arc shape in which the lower plate 16B has the rear surface of the front wall 40 as a start point and the front surface of the rib 16F adjacent to the rear side of the front wall 40 as an end point, and is bent downward. Moreover, similar to the second protrusion 35B, as viewed from the vehicle width direction, the third protrusion 35D is formed in an arc shape in which the middle plate 16D has the rear surface of the front wall 40 as a start point and the front surface of the rib 16F adjacent to the rear side of the front wall 40 as an end point, and is bent downward.

### Operation and Effects

Next, explanation follows regarding operation and effects of the fourth exemplary embodiment.

In the vehicle frame structure 10C according to the fourth exemplary embodiment, since the bent portions 35, as the deformation starting points, are configured by the first protrusion 35A, the second protrusion 35B, and the third protrusion 35D, which are formed by bending the upper plate 16A, the lower plate 16B, and the middle plate 16D, respectively, the front side member 16 may be crushed from the vehicle front side with the bent portions 35 as the start point at the time of a front collision.

### Fifth Exemplary Embodiment

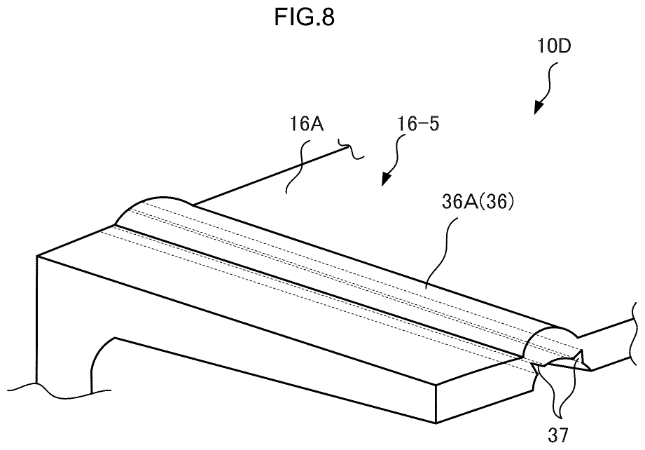

Next, explanation follows regarding a vehicle frame structure 10D according to a fifth exemplary embodiment of the present disclosure. FIG. 8 schematically illustrates a perspective view of the main parts of a front side member 16-5 of a vehicle to which the vehicle frame structure 10D according to the fifth exemplary embodiment has been applied. In the vehicle frame structure 10D according to the fifth exemplary embodiment, the same components as those of the above-described first exemplary embodiment are denoted by the same reference numerals, and explanation thereof is omitted.

As illustrated in FIG. 8, a deformation starting point portion 36 of the front side member 16-5 of the fifth exemplary embodiment further includes a fragile portion 37 with respect to the deformation starting point portion 30 of the first exemplary embodiment. Explanation follows regarding a first protrusion 36A as the deformation starting point portion 36 formed at an upper plate 16A; however, the same configuration may be applied to a second protrusion 36B and a third protrusion 36D as deformation starting point portions 36 formed at a lower plate 16B and a middle plate 16D, respectively, although the protrusion directions are different.

A groove is formed in the inner surface of the first protrusion 36A as the fragile portion 37. In the present exemplary embodiment, as an example, the groove has a cross-section with a substantially triangular shape. However, the shape of the groove is not limited to a substantially triangular shape, and may be rectangular, or the cross-sectional shape, depth, and the like may be changed. As an example, the groove is formed in the entire first protrusion 36A along the vehicle width direction as the fragile portion 37. The groove is formed in two places, an oblique front side and an oblique rear side, as viewed from the vehicle width direction.

The fragile portion 37 is not limited to a groove, and may be configured by a notch. In this case, for example, it is sufficient that at least one of the outer surface or the inner surface of each of the first protrusion 36A, the second protrusion 36B, and the third protrusion 36D be provided with a notch continuously or intermittently in the vehicle width direction. Furthermore, the fragile portion 37 may be configured by making the plate thickness thinner than other portions. In this case, for example, the plate thickness of each of the first protrusion 36A, the second protrusion 36B, and the third protrusion 36D may be thinner than the plate thickness of the upper plate 16A, the lower plate 16B, and the intermediate plate 16D.

### Operation and Effects

Next, explanation follows regarding operation and effects of the fifth exemplary embodiment.

In the vehicle frame structure 10D according to the fifth exemplary embodiment, since the deformation starting point portion 36 includes the fragile portion 37, when the front side member 16 is crushed from the vehicle front side starting from the deformation starting point portion 36 at the time of a front collision, the deformation starting point portion 36, that is, the first protrusion 36A, the second protrusion 36B, and the third protrusion 36D may be more easily deformed.

### Supplementary Explanation

In the above-described exemplary embodiments, although the front-side vehicle frame structures 10 and 10A to 10D, which are mounted at the front side of the vehicle 12, have been described as examples of the vehicle frame structure, the present disclosure is not limited thereto. The vehicle frame structure of the present disclosure may be applied to a rear-side vehicle frame structure mounted at the rear side of the vehicle 12.

Furthermore, in the above-described exemplary embodiments, although examples in which the front side members 16 and 16-2 to 16-5 are formed by casting has been described, the present disclosure is not limited thereto. For example, other than metal, the front side members 16 and 16-2 to 16-5 may be formed of carbon fiber reinforced plastics (CFRP). In this case, for example, the front side members 16 and 16-2 to 16-5 are formed by injection molding.

Furthermore, in the above-described exemplary embodiments, although the front side members 16 and 16-2 to 16-5 have been described, the present disclosure is applicable to components other than the front side members 16 and 16-2 to 16-5. For example, the present disclosure may be applied to other frame members such as a rear side member 66 (see FIG. 1) and a suspension member that is not illustrated in the drawings.

Furthermore, in the above-described exemplary embodiments, although the front side members 16 and 16-2 to 16-5 are open toward the outer side in vehicle width direction outer side, the present disclosure is not limited thereto, and the front side members 16 and 16-2 to 16-5 may open toward the inner side, or may open to both sides. In other words, the rear plate 16C may connect the inner end portions, in the vehicle width direction, of the upper plate 16A, the middle plate 16D, and the lower plate 16B, or may connect the outer end portions. Furthermore, the upper plate 16A, the middle plate 16D, and the lower plate 16B may be connected at the center in the vehicle width direction. In this case, the ribs 16F are provided at both sides, in the vehicle width direction, of the rear plate 16C.

Furthermore, in the above-described exemplary embodiments, although the front side members 16 and 16-2 to 16-5 are integrally molded with the frame main body 11, the present disclosure is not limited thereto, and a part thereof may be integrally molded. Specifically, the front wall 40 may be separately molded from the frame main body 11, and the front side member may be connected by inserting a second front side member (not illustrated in the drawings), which is separately molded, into between the front wall 40 and the front side members 16 and 16-2 to 16-5, as the side member portion integrally molded with the frame main body 11.

Furthermore, the configuration of the present disclosure is not limited to the above-described exemplary embodiments, and the configuration can be appropriately modified as long as the problem can be solved.

What is claimed is:

1. A vehicle frame structure, comprising:
a frame main body that includes a wheel house and that is integrally molded by casting;
a member portion, at least a part of the member portion being included in the frame main body, the member portion including an upper plate, a lower plate, and at least one middle plate, each of the upper plate, the lower plate, and the at least one middle plate having a plate thickness direction in a vehicle vertical direction and extending in a vehicle front-rear direction, and the at least one middle plate being provided between the upper plate and the lower plate; and
a deformation starting point portion that is provided at an outer side end portion, in the vehicle front-rear direction, of each of the upper plate, the lower plate, and the at least one middle plate, and that includes a first protrusion portion that protrudes in a vehicle upward direction at the upper plate, a second protrusion portion that protrudes in a vehicle downward direction at the lower plate, and a third protrusion portion that protrudes in the vehicle downward direction at the at least one middle plate.

2. The vehicle frame structure according to claim 1, wherein:
the member portion further includes a plurality of vertical plates that have a plate thickness direction in the vehicle front-rear direction and that connect the at least one middle plate with the upper plate and the lower plate, respectively, the plurality of vertical plates being provided at intervals in the vehicle front-rear direction; and
the first protrusion portion, the second protrusion portion, and the third protrusion portion are provided offset from the plurality of vertical plates in the vehicle front-rear direction.

3. The vehicle frame structure according to claim 1, wherein the second protrusion portion is provided at an outer side in the vehicle front-rear direction than the first protrusion portion.

4. The vehicle frame structure according to claim 1, wherein the deformation starting point portion comprises a fragile portion.

5. The vehicle frame structure according to claim 1, wherein the deformation starting point portion is configured by respective bent portions in which the upper plate, the lower plate, and the at least one middle plate are bent.

6. The vehicle frame structure according to claim 1, wherein the at least one middle plate includes a plate thickness change portion that has a plate thickness that is greater at an inner side than at an outer side in the vehicle front-rear direction.

7. The vehicle frame structure according to claim 2, wherein the deformation starting point portion is further provided between vertical plates adjacent to each other in the vehicle front-rear direction.
